(19) United States
(12) Patent Application Publication
(10) Pub. No.: US 2014/0032328 A1
(43) Pub. Date: Jan. 30, 2014

(54) Method for manufacturer coupon delivery combining incentiveized music and/or video distributed via short code technologies to personal mobile wireless devices

(71) Applicant: John Greenfield, Gulf Breeze, FL (US)

(72) Inventor: John Greenfield, Gulf Breeze, FL (US)

(21) Appl. No.: 13/561,209

(22) Filed: Jul. 30, 2012

(51) Int. Cl. G06Q 30/02

(52) U.S. Cl. CPC G06Q 30/0267
USPC 705/14.64

(57) ABSTRACT

Defines a business enterprise system of incentivizing a manufacturers coupon offer or promotion through the use of music and/or video combined with wireless mobile delivery of the manufacturers coupon, which may contain a scan-able QR code. The method describes the delivery of free (to consumer) audio or video files containing original music or visual elements combined with manufacturers discount coupons and delivered to a personal mobile wireless device. The method utilizes branded musical artist presentations (live concerts) at retail point of sale locations and delivery methods consisting of SMS and MMS short codes, email and the internet. Promotion of this method includes, but is not limited to, in-store audio containing aural instructions for short code texting to an automated server; in-store signage containing scan-able QR codes; two way short code texting; and other solicitations of gaining opt-in customer response via traditional marketing and promotion methods.

### TECHNICAL FIELD

The disclosed business enterprise system relates to SMS/MMS and email or download delivered promotional materials combined and incentivized with music and/or visuals from artistic entities thereby co-branding the artist with a manufacturers product, good or service.

### BACKGROUND

Recent advancements in the delivery of manufacturers coupons through the use of mobile devices has created new opportunities to add incentives to create a higher customer opt in percentage to a promotional campaign.

The use of short code texting to gain customers is ever increasing and will continue to increase as more smart phones, tablets and intelligent mobile wireless devices are used by consumers.

Music, and respectively, the artists that create it, have been used to enhance advertising campaigns for decades. In the past, this has been accomplished via print, television and radio advertising, what we would consider traditional forms of advertising and promotion.

Manufacturers have sponsored live concerts, artists concert tours and musical oriented events for over a century. And in doing so, create a co-branding loyalty between an artists fan base and a manufacturers product, good or service.

The model described herein is the next evolution of these and other traditional methods of coupon delivery combined with artist branding.

### SUMMARY

The provider system offers a potential customer an opt-in choice to an advertising or promotional marketing campaign, either through short code text (SMS) or scan-able QR codes from their mobile wireless device at (potentially) any venue, either retail, outdoor, or sporting event. The short code instructions can be conveyed to the potential customer through the use of in-store audio, in-store signage (including Point-Of-Sale (POS) stand-ups), and/or posters, banners and other traditional forms of print promotion. The same promotional elements are used for offering a QR code, which a potential customer may scan with their mobile wireless device.

Once a customer has responded to the provider system, they are asked to input their zip code. This is the point of Opt In for the customer. After responding to the provider system, the customer automatically receives on their mobile device, via SMS or MMS, a manufacturers coupon containing a scan-able QR code that may be used (redeemed) at their location (POS) or at a different location, venue, or even at a later date.

The customers mobile device is then automatically redirected to the provider systems home website, (the provider systems server), and is automatically cued to download a free digital music file, or video, from an artist previously selected by the provider system to co-brand with the manufacturers product, good or service. This creates a co-branded campaign promoting both the provider systems artists and music, and the manufacturers product, good or service.

The customer may receive additional offers from the provider system representing other manufactures and/or artists over the course of time directly to their mobile device from the provider system.

At any time, the customer has the ability to “Opt-Out” of the provider system by simply texting STOP to the provider systems dedicated short code technology.

### BRIEF DESCRIPTION OF THE DRAWINGS

FIG. 1 is a block diagram of the Business Enterprise System Model-Utilizing audio/video as an incentive for maximizing customer opt-in response within a coupon delivery campaign.

### DETAILED DESCRIPTION

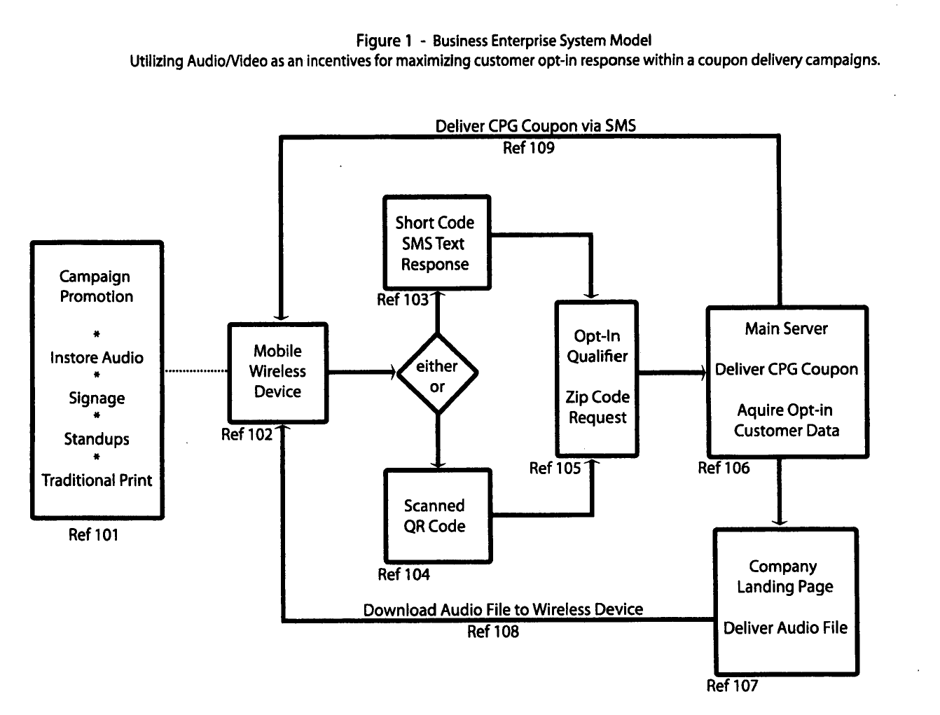

FIG. 1 is a block diagram detailing the relationships between the various functions and relationships contained within the provider system.

Ref 101 depicts a traditional mean of soliciting a customer opt in response. These include, but are not limited to the use of in-store audio directing a customer to text an artists name via a short code text to the provider systems server; in store signage (either attached to a shelf or a poster) directing a customer to either 1) text an artists name via a short code text to the provider systems server, or 2) scan a QR code printed onto the print advertisement that will direct the customers mobile wireless device to the provider systems server; Stand ups of the artist that direct a customer to either 1) text an artists name via a short code text to the provider systems server, or 2) scan a QR code printed onto the print advertisement that will direct the customers mobile wireless device to the provider systems server or; traditional print media such as flyers or tabletops that direct a customer to either 1) text an artists name via a short code text to the provider systems server, or 2) scan a QR code printed onto the print advertisement that will direct the customers mobile wireless device to the provider systems server.

Ref 102 depicts a customers mobile wireless device. This can be a cellular phone, smart phone, tablet, or any other device that operates, or can operate via wireless cellular communication.

Ref 103 depicts the short code text response that a customer may choose to establish a response to any of the traditional promotions depicted in Ref 101. The customer will text an artists name to an SMS short code, thereby connecting his/her mobile wireless device to the provider systems server.

Ref 104 depicts the QR code scan response that a customer may choose to establish a response to any of the traditional promotions depicted in Ref 101. The customer will scan the QR code printed on a shelf sign, poster, stand up etc with his/her mobile wireless device thereby connecting his/her mobile wireless device to the provider system via texting.

Ref 105 depicts the Opt-In qualifier that determines, among other things, the geographical location of the consumer. When the customer has either short code texted or scanned a QR code, the provider systems servers solicit a question to the consumer via SMS texting. This question can be “What is your Zip Code”, but can also be any of a multiple of response solicitations from the provider systems servers to the customer. This solicited response acts to “qualify” a customer as either Opted-In to the campaign or not. Further, it provides the provider system with valuable information about the customer that can be utilized in future campaigns.

Ref 106 depicts one of two main servers comprising the provider system. This particular server is maintained outside the provider system and is leased to provide SMS and MMS delivery of advertising coupons to a customer. This server further acquires a customer's opt-in data that is forwarded to the Company Landing Page (Ref 107). When this server receives the customers opt-in data, it automatically responds to the customer in two ways: 1) it delivers a predetermined manufacturers coupon containing a QR code that provides a discount for the manufacturers products, good and/or services directly to the customers mobile wireless device via MMS technologies; and 2) it sends a hot link, or website URL 1 to the customers mobile wireless device via SMS technologies that when clicked upon by the customer, connects the customers mobile wireless device to a private page contained within the Company Landing Page whereby enabling the customer to download an artists digital music file and/or video directly to the customers mobile wireless device.

Ref 107 depicts the Company Landing Page that a consumer is directed to via SMS technologies to download an artists music and or video. This server is the main server of the provider system and functions as the delivery medium for an artists music and videos, as well as a company website for the provider system. When a customer has completed the download of the music and/or video that the customer has opted-in to receive on their mobile wireless device, the customer will be automatically directed to the main home page of the company website operating the provider system.

Ref 108 depicts the physical delivery of the music and/or video from the provider systems website to the customers wireless mobile device. The delivery method can be direct download via email, MMS or other technologies.

Ref 109 depicts the physical delivery of a manufacturers coupon from the leased outside server of the provider system to the customer via SMS or MMS technologies. Upon delivery of the coupon, which contains embedded QR codes from the manufacturer, the customer now has the ability to utilize the delivered coupon immediately through OCR scanning in a retail environment, or though other redemption methods to be determined.

What is claimed is:

1. A method of promotional and/or advertising campaigns wherein manufacturer discount coupons are incentivized with the inclusion of free music and/or video.

2. The method of claim 1, wherein the customer receives and acknowledges (through their mobile wireless response) the opt-in short code or scan-able QR code instructions to receive a manufacturers coupon and an artists digital music file via in-store audio, in-store signage, or other more traditional means of promotions including, but not limited to magazine advertisements, festival banners, indoor or outdoor billboards, radio advertisements, television advertisements, table tents, full size in-store stand-ups, newspaper advertisements, theater advertisements, or word of mouth.

3. The method of claim 1, wherein the provider system maintains full and complete license on any artist's music and visual rights.

4. The method of claim 1, wherein the provider system pays any and all applicable licensing fees to its artists, and the respective musical Publishing Rights Organizations (PRO's) i.e. BMI, ASCAP and SESAC.

5. The method of claim 1, wherein the provider system delivers manufacturers coupons for a fee, paid by the manufacturer to the provider system, which includes the cost of acquisition of the manufacturers coupon plus the additional costs of music and video delivered to the consumer.

6. A method of wirelessly delivering a manufacturers discount coupon along with an artists digital music and/or video to a consumer via SMS and MMS short code texting technologies directly to the consumers mobile wireless device.

7. The method of claim 6, wherein the customer has a mobile wireless device capable of transmitting and receiving SMS and MMS texts, and emails.

8. The method of claim 6, wherein the customer must “opt-in” to the campaign by texting an artists name via a dedicated short code via his/her wireless mobile device.

9. The method of claim 6, wherein the provider system requests certain information from the customer via SMS technologies to validate the customers Opt-In choice.

10. The method of claim 6, wherein the provider system requests certain information from the customer via SMS technologies as a means of acquiring data from the customer for inclusion within the provider systems database.

11. The method of claim 6, wherein a manufactures coupon is delivered directly to a customers mobile wireless device via SMS or MMS technologies.

12. The method of claim 6, wherein an artists music and/or visual digital files are delivered directly to a customers mobile wireless device through a browser, internet or MMS technologies.

13. A method of Advertising Co-Branding a manufacturers products, goods or services with the provider service's artists music and/or videos.

14. The method of claim 13, wherein an artist, and his/her music becomes recognized through the campaign as being associated with, or representing a manufacturers products, goods or services.
